(19) United States
(12) Patent Application Publication
(10) Pub. No.: US 2016/0371469 A1
(43) Pub. Date: Dec. 22, 2016

(54) Method of security to discourage illegal copying of digital files containing copyrighted work or works and give value to said files using symmetric cryptography.

(71) Applicant: Johnie Ruben Adams, JR., Edmond, OK (US)

(72) Inventor: Johnie Ruben Adams, JR., Edmond, OK (US)

(21) Appl. No.: 14/745,391

(22) Filed: Jun. 20, 2015

(51) Int. Cl. G06F 21/10

(52) U.S. Cl. CPC G06F 21/10

(57) ABSTRACT

This invention involves a method of security in which every ‘filename representing a digital copy of a digital file containing a copyrighted work or works’ (filename/file) is created in a consistent order to contain a trademark of the entity under whom authority of the copy has been made, the file title, the file title identification number, an identification number of the copy, the name or abbreviation of the entity producing said copy, and any other identification information as may be needed where all identification numbers are created by symmetric cryptography.

This method of security when combined with routine software processes makes possible a means to determine if the entity in possession of a particular filename/file is the registered owner, or not, and the means to transfer ownership of a said filename/file from one entity to another.

### BRIEF SUMMARY OF THE INVENTION

This invention involves a method of security in which every ‘filename representing a digital copy of a digital file containing a copyrighted work or works’ (filename/file) is created in a consistent order to contain a trademark of the entity under whom authority of the copy has been made, the file title, the file title identification number, an identification number of the copy, the name or abbreviation of the entity producing said copy, and any other identification information as may be needed where all identification numbers are created by symmetric cryptography. As every file stored in a computer or mobile device's permanent storage is represented by a filename and as modern operating systems can use filenames up to 256 characters in length, it is possible to give specific identification to each filename/file.

This method of security when combined with routine software processes makes possible a means to determine if the entity in possession of a particular filename/file is the registered owner, or not, and the means to transfer ownership of a said filename/file from one entity to another.

### DESCRIPTION

1. Field of the Invention

This invention, generally, discourages illegal copying of digital files containing copyrighted work(s). More particularly, it is a method which produces a consistent, unique identification of a filename, using symmetric cryptography for the generation of identification numbers, which represents a particular digital file copy containing a copyrighted work(s). Because of this, anyone in possession of said file can prove whether, or not, they are the registered owner of said file, and copies of digital files containing copyrighted work(s) with said identification now have the ability to be bought and sold from one entity to another.

2. Description of the Prior Art

There have been many processes using various hardware or software encryption/endoding/token solutions patents such as using a scanning process to tag a file or using encrypted physical location data to determine which digital file is the original.—see list of referenced patents

With regard to any hardware or software solution, given enough time, any can be reverse engineered or the encryption/encoding/token process discovered. Examples include set top boxes for cable television and dvd encoding.

Other patents have used numbers to identify copyrighted works such as assigning numbers or alpha-numeric combinations to identify a specific copyrighted work to allow a user to pay to utilize said copyrighted work on a specific machine. An example is a patent for making a phonographic selection in what is commonly referred to as a “juke box”.—see list of referenced patents

Other patents have been granted to provide a physical tag for article identification. In this regard, there are many examples of software replacing hardware solutions, where applicable. For example, the transmission of faxes used to require a fax machine to scan a printed document. Now, the document, never having been printed to paper, may be sent directly to a fax machine, or, more likely, attached to an email.—see list of referenced patents

Because a digital copy of a digital file containing copyrighted material(s) can be absolutely identical to the original, as well as copies of copies, ad infinitum, and with over three billion people connected to the internet, it has been impossible to enforce copyright law(s), in countries where applicable. As a result, there are literally millions upon millions of illegal copies of copyrighted files.

While it is unlikely anything can be done with existing illegal copies, all new copies may now make use of this new method of filename identification.

Thus, this useful invention can help solve a very serious internet-centric problem. The invention described herein has the following advantages over previous methods:

1. One can tell at a glance if a filename may be an illegal copy.

2. Any time the file is copied, if the filename's identification number does not change, the copy is illegal.

3. Anyone in possession of a copy utilizing this method can easily determine if they are listed as the legitimate owner, therefore, they will know if they are in possession of an illegal copy.

4. If a person is in possession of multiple copies utilizing this method with the same identification number, without the creator's permission, they are guilty of copyright infringement.

Due to the ease of making copies of digital files, the general public has the perception that digital files of copyrighted material are worthless. This is most apparent when the copyrighted material is a music file.

Thus, utilizing this invention, the general public will realize digital files can have value.

3. Specific References of Prior Art

U.S. Pat. No. 8,286,255 Computer file control through file tagging-data is scanned and confidentiality tag is added to filename which can cause interruption to the intended communication. Aug. 7, 2008 Oct. 9, 2012 Grant; Calum Anders McKay (Didcot, GB), Todorovic; Rade (Abingdon, GB), Thomas; Andrew James (Oxfordshire, GB), Jacobs; Richard (Oxford, GB)

U.S. Pat. No. 8,032,542 Creating, verifying, managing , and using original digital files-one method includes identifying the actual physical location of the file and associating that physical location with the file itself as the claimed physical location of the file. Oct. 24, 2001 Oct. 4, 2011 Reynolds; Mark L. (Provo, Utah)

U.S. Pat. No. 4,045,776 Electronic phonograph select and memory system- corresponding respectively to the digits adapted to make up a selection identification number. Apr. 19, 1976 Aug. 30, 1977 Wheelwright; Robert W. (Tonawanda, N.Y.), Solender; Peter E. (Williamsville, N.Y.)

U.S. Pat. No. 4,893,840 Article identification label and method of article identification-label includes a tag affixed to a surface of the article and containing identifying indicia visible to the naked eye. Apr. 15, 1988 Jan. 16, 1990 Berkowitz; William E. (Skokie, Ill.)

### SUMMARY OF THE INVENTION

The mode of implementing this invention is in using new copies of newly created copyrighted work(s) and the internet, also known as the “world wide web”, using a typical server setup with appropriate levels of typical bandwidth and storage; accessed by any typical user device, either mobile or stationary, utilizing whatever hardware and/or software that is used to access the internet. Any person skilled in the art of any number of computer programming languages may implement this invention.

The long-standing, but heretofore unfulfilled need to discourage the illegal copying of digital files containing copyrighted work(s) is now met with a new, useful, and non-obvious inventive method:

1. Creator(s) of original file containing copyrighted work(s) uploads said file and other information as may be required to the ‘entity and/or system’ (database id or, simply, did) who has ownership or control of the database ‘or databases’ (s) wherein the file and information resides.

4. The filename of said file is changed to a consistent order, as determined by the entity producing said copy, to contain a trademark of the entity under whom authority of the copy has been made, the file title, the unique file title identification number, a unique identification number of the copy, the name or abbreviation of the entity producing said copy, and any other identification information as may be needed where all identification numbers are created by symmetric cryptography.

### BRIEF DESCRIPTION OF FIGURES (FLOW CHARTS, AND/OR DRAWINGS) INTEGRATING THIS METHOD IN THE TOTAL PROCESS.

FIG. 1 A, FIG. 1 B: reception of file containing copyrighted work(s), conversion of said file's filename, reception of buyer's unique identification, and storage of same.

FIG. 2 A, FIG. 2 B: buyer check to see if they are the registered owner of filename of file containing copyrighted work(s).

FIG. 3 A, FIG. 3 B, FIG. 3 C: transfer of ownership of filename of file containing copyrighted work(s).

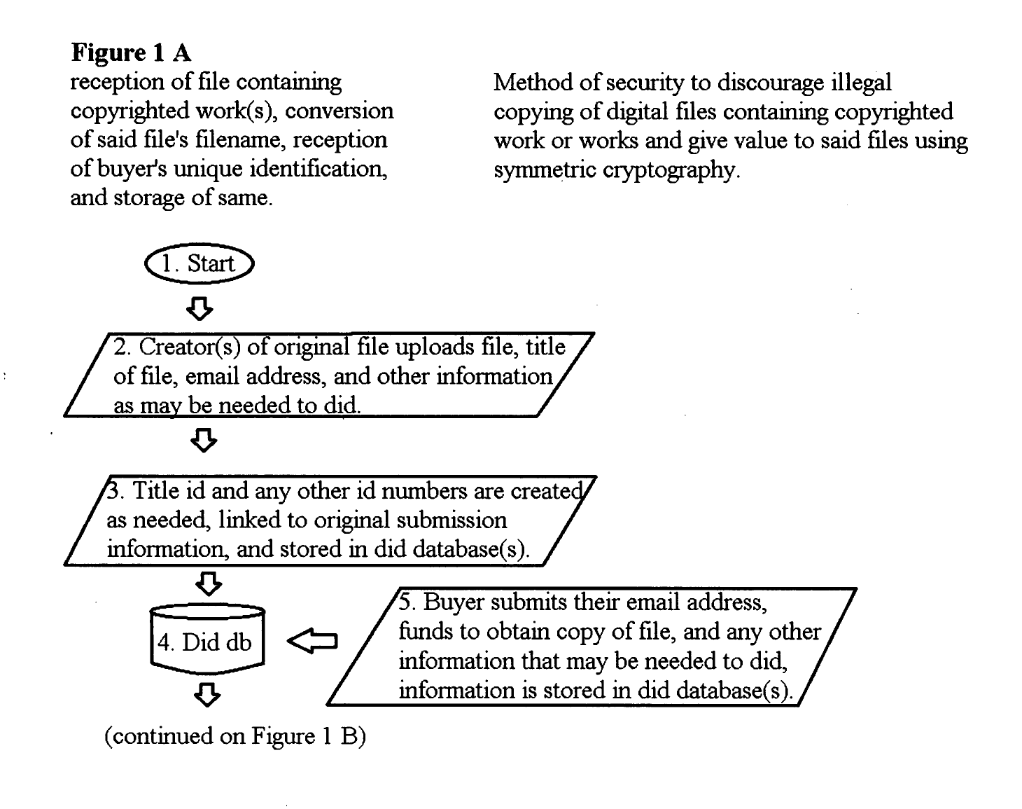

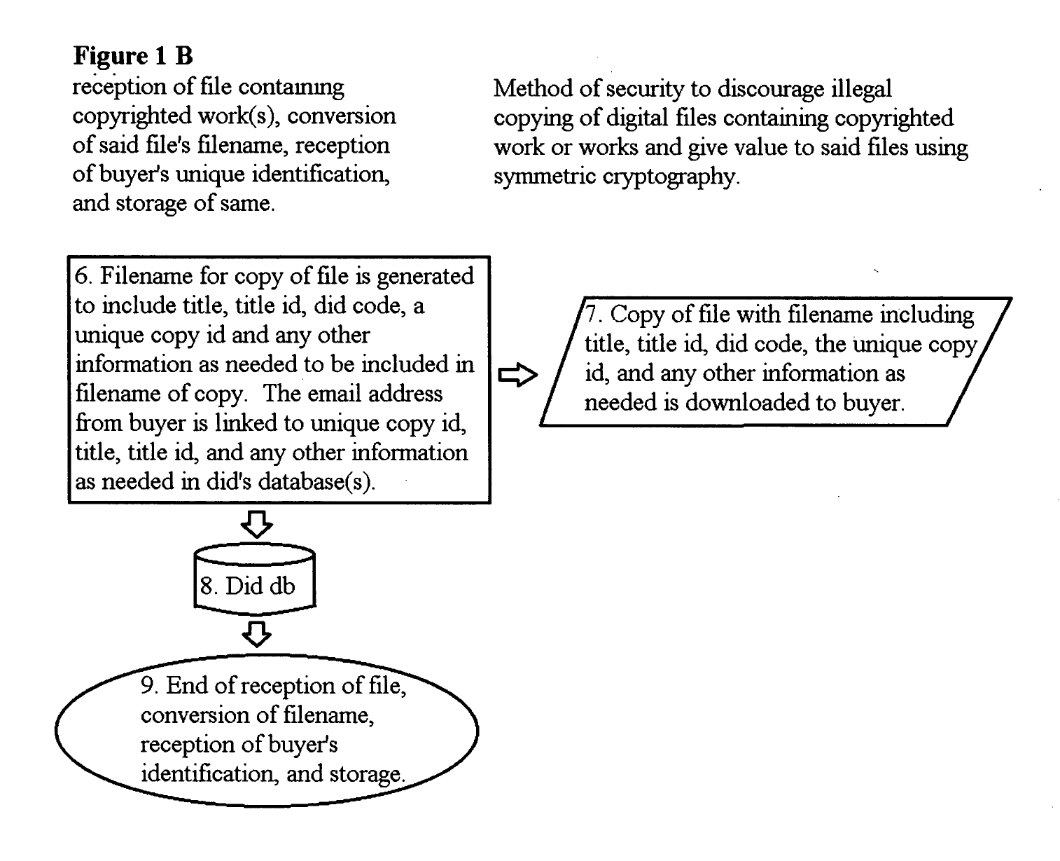

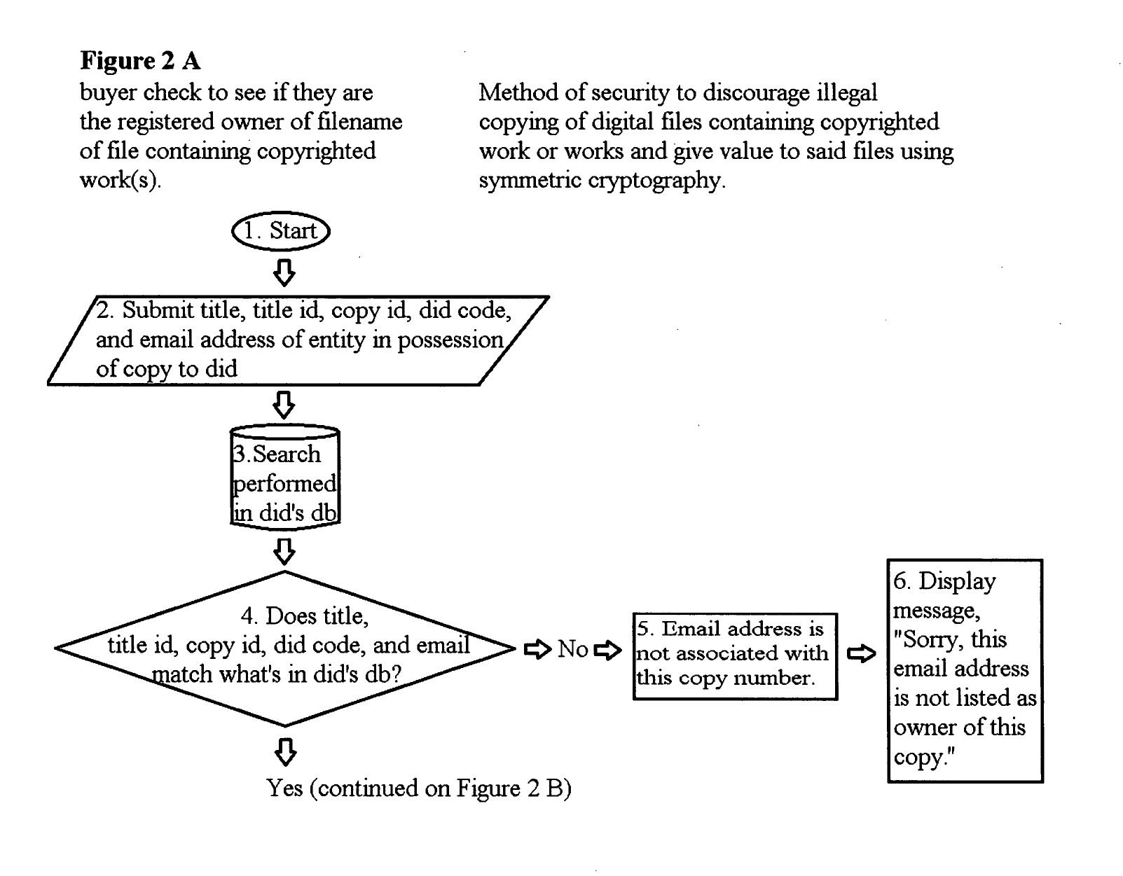

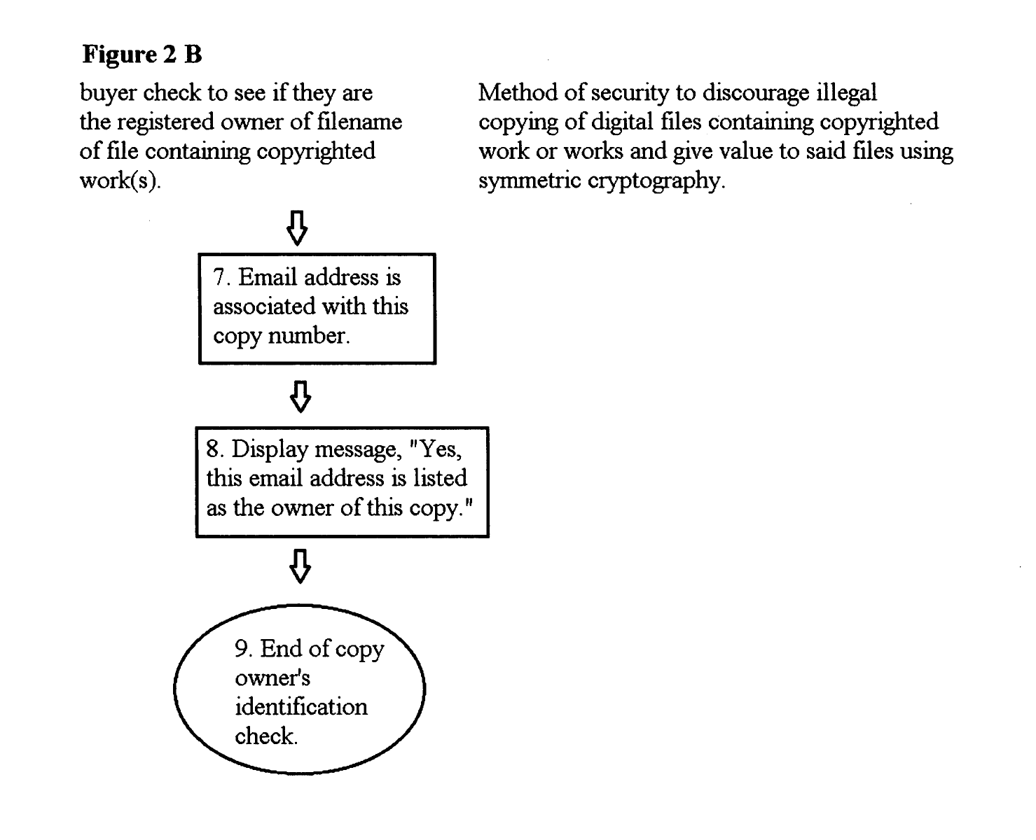

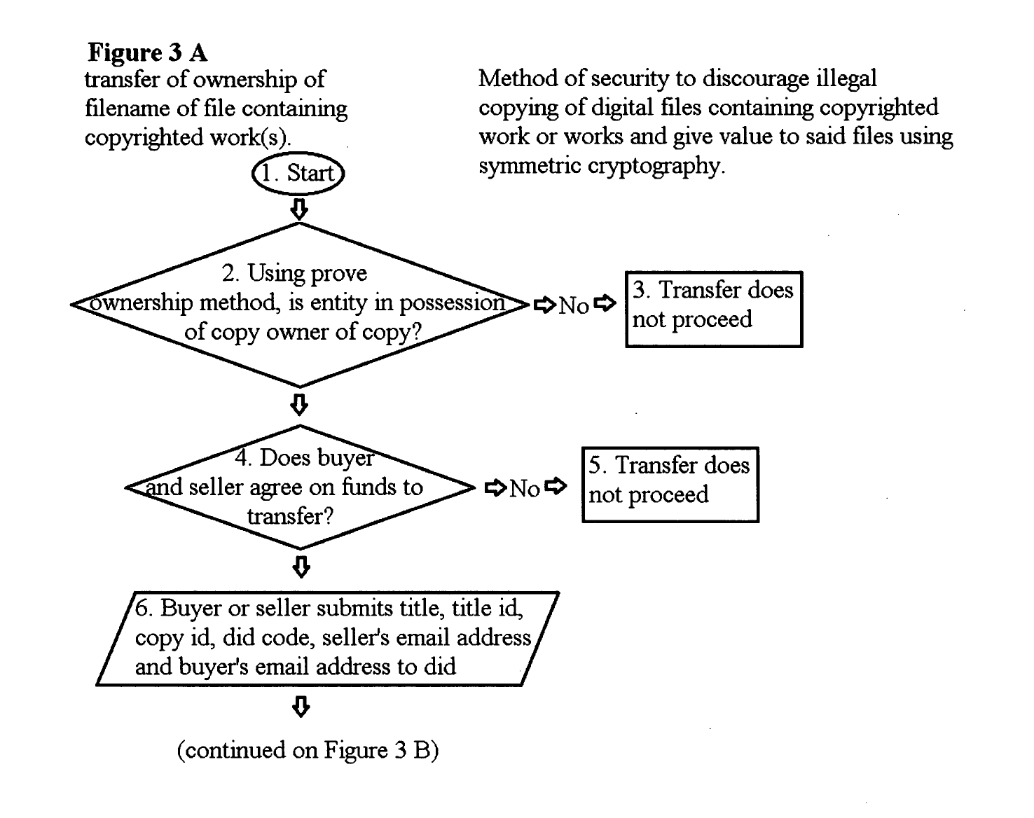

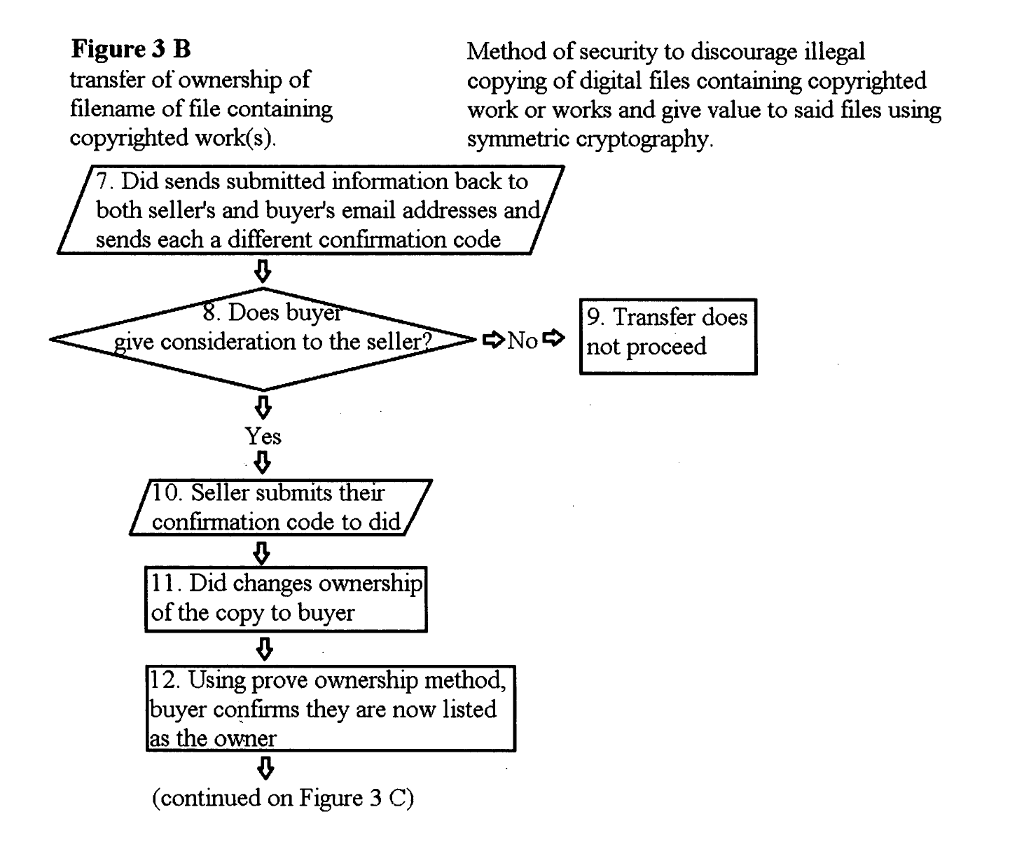

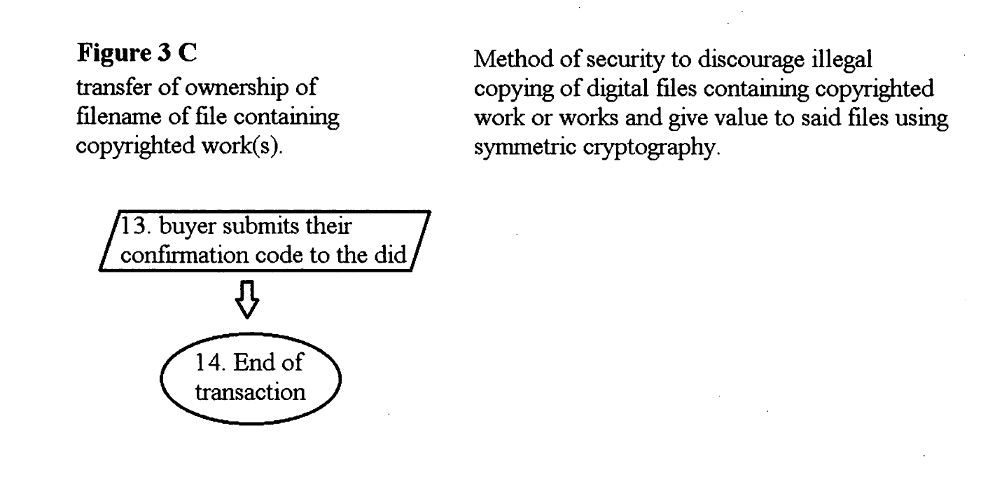

### DETAILED DESCRIPTION OF AN EMBODIMENT UTILIZING THIS METHOD

The following is an illustrative embodiment utilizing this novel method to discourage illegal copying and give value to a music file in three instances.

1. Sale of digital copy of music file:
Creator(s) of original music file uploads said file and other information as may be required to the entity and/or system (did) who has ownership or control of the database(s) wherein the file and information will reside.

A trademark, unique title identification number, and any other unique identification numbers are created, as needed, and are linked to submission information and stored in did database(s), as follows:
Title is checked to see if any previous titles are identical. If there are no identical titles, it is given an identification number of 1. If there are previous identical titles, it is given an identification number of the largest, plus 1.
Name of the artist(s) is checked to see if any previous names are identical. If there are no identical names, it is given an identification number of 1. If there are previous identical names, it is given an identification number of the largest, plus 1.
A unique, sequential identification number is given to the filename starting with 0, using symmetric cryptography, by way of a base 60 (sexagesimal) numbering system with numbers 0-9 and upper and lower case letters of the English alphabet with the exception of O (upper case o) and 1 (lower case L) as they are easily confused with the numbers 0 and 1.
The resulting filename will appear as follows where the encircled lower case t is the trademark of the entity who has the authority to make the copy, “I'm Not There” is the tile of the music, title id is the title's identification number, “Danielle Grace” is the name of the artist(s), name id is the name's identification number, copy id is the identification number of the copy, tnmb is the abbreviation of the entity making the copy as authorized by the trademark entity and .mp3 is the file extension.

\textcircled{t} I'm Not Ready copy id.Danielle Grace.title id.name id.mp3 The 100,000^{th} copy filename of this file, with title id and name id of 1 would be:

\textcircled{t} I'm Not Ready Smf.Danielle Grace.1.1.mp3

Buyer uploads their email address and any other unique identifying information as may be needed and whatever consideration is required to obtain a copy of the copyrighted work(s) to did and third party payment system, if needed.

Did stores buyer information in did database(s).

When buyer's consideration has been confirmed, their copy is generated and its filename is created, as above.

Buyer's email address and any other unique buyer information as may be needed are linked to the unique filename generated as above in did database(s).

Copy of the original copyrighted work(s) with filename as described above is downloaded to buyer.

Common business practice includes periodic consideration being sent to creator(s) of the music file based on number of sales and a process to remove from sales the music file by the creator(s) as may be needed. All copyright privileges remain with the creator(s) at all times.

2. Check to see if entity in possession of file containing copyrighted work(s) with filename as described above is the legitimate owner:

Person in possession of a file containing copyrighted works(s) that has had its filename created as the above, uploads title, the copy identification number, title identification number, and did abbreviation and the email address they used to purchase said filename/file.

Search is performed on the appropriate database(s) to see if information is linked.

Did downloads an affirmative answer if all the submitted information is linked in its database(s), indicating the possessor is the owner of the filename/file. If information submitted is not linked, a negative answer is downloaded.

3. Transfer of ownership of file containing copyrighted work(s) with a filename as above:

New buyer uses step 2, as above, to prove seller is registered owner of filename/file.

If person in possession of file is legitimate owner as determined in above step, buyer and seller negotiate a satisfactory consideration. If person in possession is not legitimate owner, transfer does not proceed.

When agreement is reached on consideration to be received by seller, either buyer or seller uploads filename information, along with email addresses of both buyer and seller.

Did emails both buyer and seller with information regarding transfer of file as uploaded, along with confirmation links and/or confirmation codes.

If information submitted to buyer is correct, buyer gives consideration to seller. If information is not correct, transfer does not proceed.

When seller receives consideration for transfer of ownership, they give notice by activating the transfer link and/or return transfer code. If seller does not receive consideration, they do not activate transfer link and/or return transfer code, transfer does not proceed.

When buyer activates their transfer link and/or returns their transfer code and seller has activated their transfer link and/or returns their transfer code, buyer's email address replaces seller's email address linked to filename of the copy of the file containing copyright work(s).

Buyer uses procedure of step 2. to confirm ownership of filename of the file containing copyrighted work(s) has been changed to their email address.

What is claimed is:

1. A method of security to authenticate ownership of a digital filename/file containing copyrighted work(s) and to transfer ownership of said filename/file from one entity to another to discourage illegal copying and to give value to said filename/file uses the following new, useful method comprising:
every word, letter, number, or symbol in a filename representing a digital copy of a digital file containing copyrighted work(s) is created in a consistent order, as determined by the entity producing said copy, to contain a trademark of the entity under whom authority of the copy has been made, the file title, the file title identification number, a unique identification number of the copy, the name or abbreviation of the entity producing said copy, and any other identification information as may be needed where all identification numbers are created by symmetric cryptography in sequential order.
to generate said identification numbers using symmetric cryptography, a consistent alpha-decimal numbering system is utilized for numbers smaller than about one sextillion (1,000,000,000,000,000,000,000). Larger identifying numbers will use a consistent Asian character-decimal numbering system.
